(19) United States
(12) Patent Application Publication
(10) Pub. No.: US 2019/0126482 A1
(43) Pub. Date: May 2, 2019

(54) INFORMATION PROCESSING DEVICE AND PROCESS PLAN DISPLAY METHOD

(71) Applicant: Fujitsu Limited, Kawasaki-shi (JP)

(72) Inventor: Satoshi TOMITA, Kawasaki (JP)

(73) Assignee: Fujitsu Limited, Kawasaki-shi (JP)

(21) Appl. No.: 16/127,855

(22) Filed: Sep. 11, 2018

(30) Foreign Application Priority Data
Oct. 31, 2017 (JP) 2017-210722

(51) Int. Cl. B25J 9/16; G05B 19/418

(52) U.S. Cl. CPC B25J 9/1682; G05B 19/41815; B25J 9/1656

(57) ABSTRACT

An information processing device includes: a memory; and a processor coupled to the memory and configured to: assign a task to be executed to each arm of a robot system having arms; determine an execution time period for each operation included in each task assigned to the each arm based on whether the each operation is an operation in an interference region, in which the arms interfere with each other, or an operation in a non-interference region, in which the arms do not interfere with each other; and display workload charts of the arms side by side, an execution time period for each operation and a time period during which no operation is executed being arranged along a time axis in the workload chart of the each arm.

### CROSS-REFERENCE TO RELATED APPLICATION

This application is based upon and claims the benefit of priority of the prior Japanese Patent Application No. 2017-210722 filed on Oct. 31, 2017, the entire contents of which are incorporated herein by reference.

### FIELD

A certain aspect of the embodiments described herein relates to an information processing device, a non-transitory computer readable storage medium, and a process plan display method.

### BACKGROUND

In process planning for line production, there is a case where an information processing device assigns tasks to persons (workers) and automated machines such as robots, and then presents individual workloads to a process designer with use of a workload chart (a piling chart) to cause the process designer to check the appropriateness of the assignment result.

When the automated machines used in the line production are machines each dedicated for a single task, the workload of the task assigned to the automated machine is small. Thus, it is hardly necessary to consider a load balance between the persons and the automated machines. Thus, even when the workload of the automated machine is displayed in the same manner as the workload of the person, no particular problem arises.

On the other hand, when the use of a general-purpose robot system is expanded in line production, the type and amount of tasks executed by a robot increases. Thus, the process designer needs to adjust not only the workload of the person but also the load balance between the person and the robot. For example, the process designer needs to make adjustments such as allowing a robot to execute as many tasks as possible while keeping a person from waiting for the end of the task by the robot.

In addition, in assembly work including complicating steps such as cable forming, typified by assembly work of a notebook personal computer (PC), a task requiring multiple arms and a task requiring only one arm may be mixed. When a general-purpose robot system includes a plurality of arms, to efficiently use the robot, it is necessary to design the process so that the plurality of arms efficiently move appropriately.

### SUMMARY

According to an aspect of the embodiments, there is provided an information processing device including: a memory; and a processor coupled to the memory and configured to: assign a task to be executed to each arm of a robot system having arms; determine an execution time period for each operation included in each task assigned to the each arm based on whether the each operation is an operation in an interference region, in which the arms interfere with each other, or an operation in a non-interference region, in which the arms do not interfere with each other; and display workload charts of the arms side by side, an execution time period for each operation and a time period during which no operation is executed being arranged along a time axis in the workload chart of the each arm.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 schematically illustrates a hardware configuration of an information processing device in accordance with an embodiment;

FIG. 2 is a functional block diagram of the information processing device;

FIG. 3 illustrates a data structure of a task DB;

FIG. 4 is a diagram for describing an overview of a robot system;

FIG. 5A through FIG. 5D are diagrams (No. 1) for describing data stored in a priority DB;

FIG. 6A through FIG. 6D are diagrams (No. 2) for describing data stored in the priority DB;

FIG. 7 is a flowchart of a process executed by the information processing device;

FIG. 8 is a diagram (No. 1) for describing the process executed by the information processing device;

FIG. 9A and FIG. 9B are diagrams (No. 2) for describing the process executed by the information processing device;

FIG. 10A and FIG. 10B are diagrams (No. 3) for describing the process executed by the information processing device;

FIG. 11A and FIG. 11B are diagrams (No. 4) for describing the process executed by the information processing device;

FIG. 12 illustrates a screen displaying a process plan; and

FIG. 13 is an enlarged view of a workload chart of a robot system in FIG. 12.

### DESCRIPTION OF EMBODIMENTS

When the general-purpose robot system executes complicating assembly work including cable forming or the like, the information processing device executes a process of assigning tasks using a single arm and cooperative tasks using a plurality of arms to the arms arranged adjacent to each other. In this case, the process designer needs to check the appropriateness of the processing result (for example, whether there is interference between arms, and whether there is no unnecessary stop of operation). However, it is difficult to check whether there is interference between arms and whether there is no unnecessary stop of operation with use of the conventional workload chart.

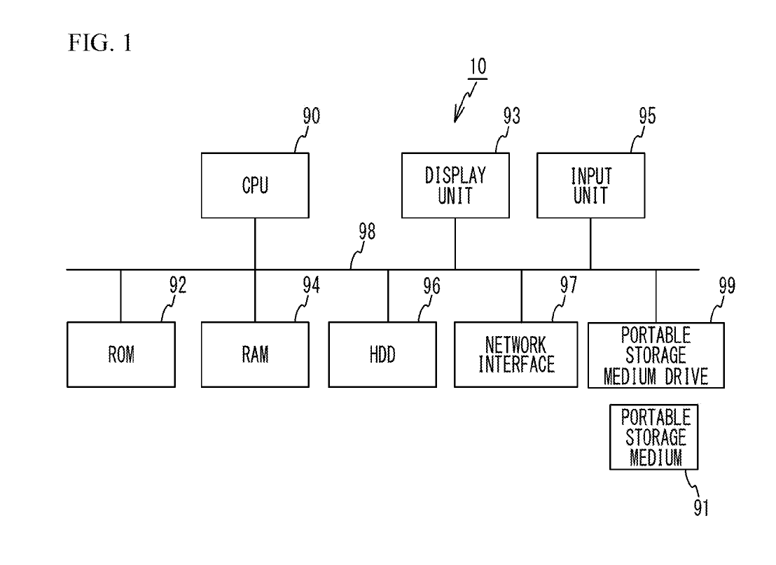

Hereinafter, an embodiment of an information processing device that assists designing a process plan by a process designer will be described in detail with reference to FIG. 1 through FIG. 13.

An information processing device 10 of the present embodiment is a device that generates a process plan (an assignment plan of tasks to a person and a robot system) in an assembly line including a person and a robot and displays the generated process plan to cause the process designer to evaluate the appropriateness of the generated process plan.

In the present embodiment, in the assembly line, a product is conveyed from one station to another station by a conveyor (not illustrated). A person or a robot system is assigned to each station of the assembly line. The person or the robot system assigned to each station executes tasks assigned according to the process plan to the product conveyed in the assembly line to produce products. The number of persons and the number of robot systems are freely selected. Thus, the number of robot systems may be one or two or more.

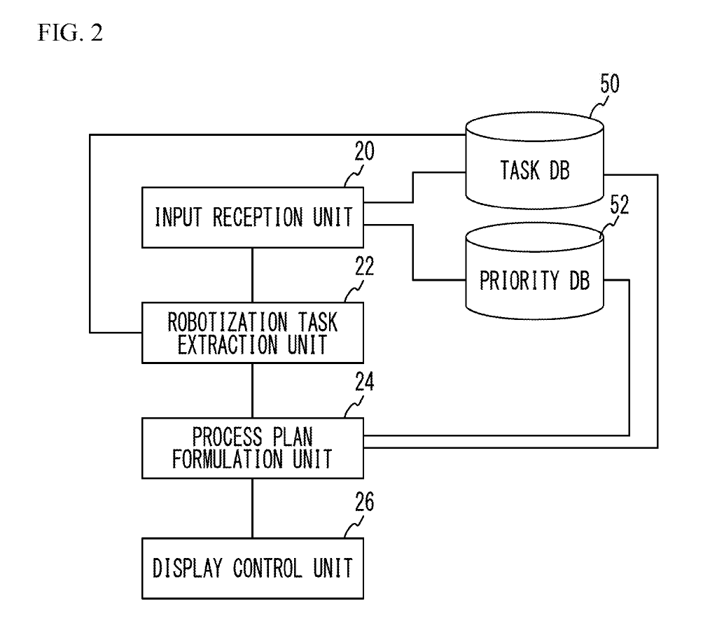

FIG. 1 illustrates a hardware configuration of the information processing device 10. The information processing device 10 is, for example, a personal computer (PC), and includes a central processing unit (CPU) 90, a read only memory (ROM) 92, a random access memory (RAM) 94, a storage unit (here, a hard disk drive (HDD)) 96, a network interface 97, a portable storage medium drive 99, a display unit 93, and an input unit 95 as illustrated in FIG. 1. Examples of the display unit 93 include, but are not limited to, a liquid crystal display or the like, and examples of the input unit 95 include, but are not limited to, a keyboard, a mouse, and a touch panel. Each component of the information processing device 10 is connected to a bus 98. A function of each unit illustrated in FIG. 2 is implemented in the information processing device 10 by the CPU 90 executing programs (including a process plan display program) stored in the ROM 92 or the HDD 96 or programs (including the process plan display program) read from a portable storage medium 91 by the portable storage medium drive 99. FIG. 2 also illustrates a task database (DB) 50 and a priority DB 52 stored in the HDD 96 or the like of the information processing device 10. Examples of the portable storage medium 91 include, but are not limited to, a CD-ROM, a DVD disc, a portable storage medium such as a Universal Serial Bus (USB) memory, and a semiconductor memory such as a flash memory.

FIG. 2 illustrates a functional block diagram of the information processing device 10. As illustrated in FIG. 2, the execution of a program by the CPU 90 causes the information processing device 10 to function as an input reception unit 20, a robotization task extraction unit 22, a process plan formulation unit 24 as an assignment unit and a determination unit, and a display control unit 26.

The input reception unit 20 receives information on tasks required to be executed in a production line and information on a priority of each task, which are input by a process designer through the input unit 95, and stores the information in the task DB 50 and the priority DB 52. In addition, when the process designer inputs information to modify the process plan displayed on the display unit 93, the input reception unit 20 receives input of the modification information, and transmits the modification information to the robotization task extraction unit 22.

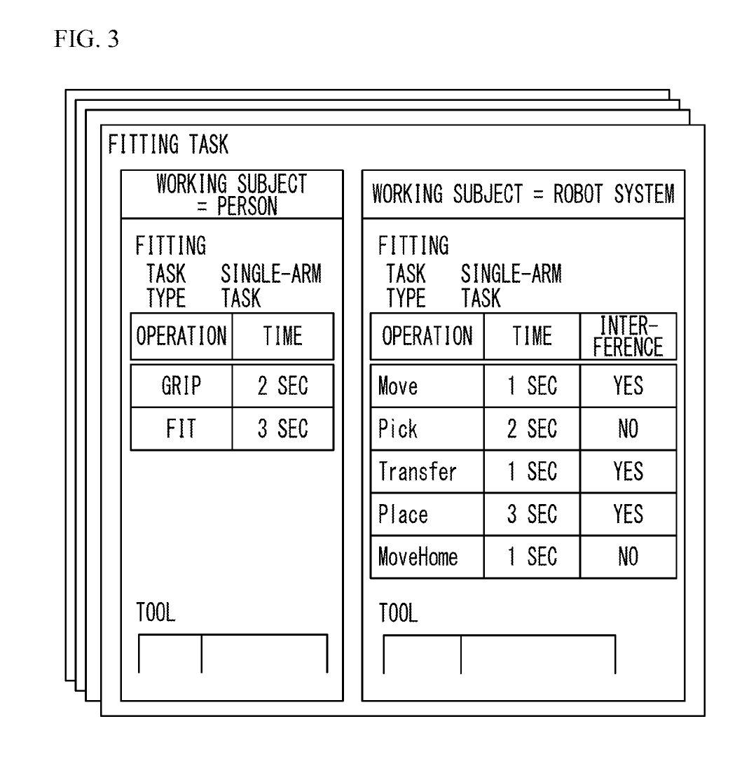

Here, the task DB 50 is a database storing information on each task as illustrated in FIG. 3. The task includes one or more operations, and the information on each task includes information on operations, a task type, and information on necessary tools when a person executes the task (a working subject is a person), and information on operations, a task type, and information on necessary tools when a robot system executes the task (a working subject is a robot system). For example, in the case of a “fitting task” illustrated in FIG. 3, when the working subject is a person, the task type is a single-arm task, and the operations are “GRIP” and “FIT”. Additionally, the time required for the task (the sum of operation times) is 5 seconds. On the other hand, when the working subject is a robot system, the task type is a single-arm task, the operations are “Move”, “Pick”, “Transfer”, “Place”, and “MoveHome”. The time required for the task is 8 seconds. Additionally, among these operations of the robot system, “Move”, “Transfer”, and “Place” are operations in an “interference region” described later (referred to as an interference operation), and “Pick” and “MoveHome” are operations in a “non-interference region” described later (referred to as a non-interference operation).

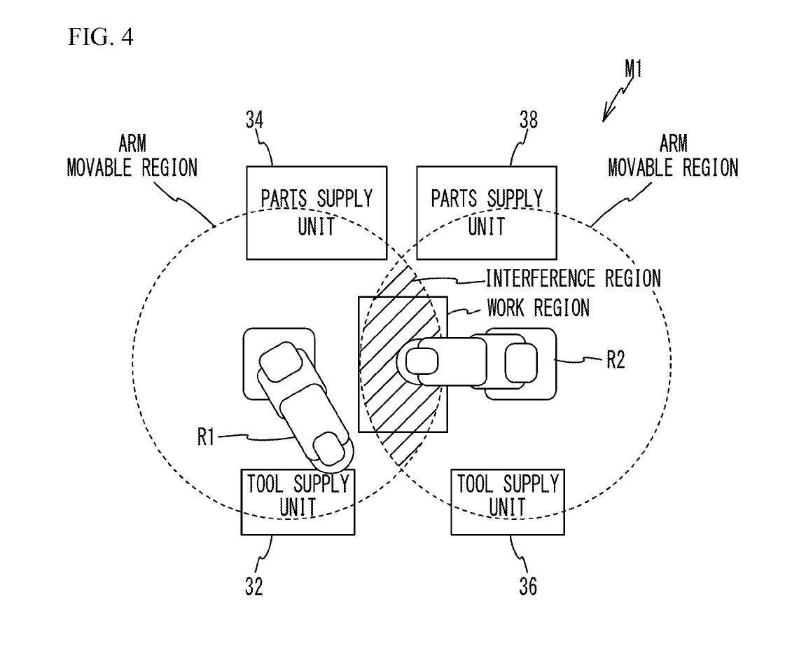

Here, the present embodiment uses a robot system M1 having two arms R1 and R2 as the robot system, as illustrated in FIG. 4. A tool supply unit 32 and a parts supply unit 34 are located in the movable region of the arm R1, while a tool supply unit 36 and a parts supply unit 38 are located in the movable region of the arm R2. In the tool supply units 32 and 36, the arms R1 and R2 change tools to be used (execute tool change). In the parts supply units 34 and 38, the arms R1 and R2 execute an operation to pick up a part (execute the operation “Pick”). In a work region illustrated in FIG. 4, the arms R1 and R2 individually or cooperatively execute tasks. In the present embodiment, since there is a case where the arms R1 and R2 cooperatively execute a task, the movable regions of the arms R1 and R2 partly overlap with each other. The overlapping region is the “interference region” in which the arms R1 and R2 may interfere with each other, and the region other than the interference region of the movable region of each arm is the “non-interference region”. In the present embodiment, while one of the arms executes a single-arm task (a task other than a cooperative task) in the interference region, to avoid collision between the arms, the other of the arms executes the non-interference operation or waits in the non-interference region.

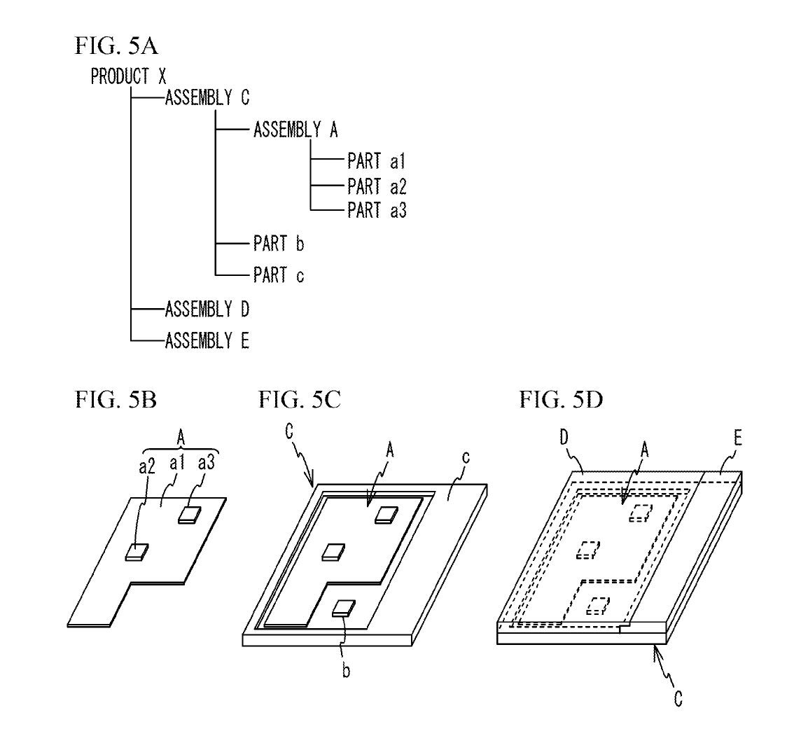

Referring back to FIG. 2, the priority DB 52 stores information on a priority of each task. For example, it is assumed that there is a product X having a parts structure and an assembly structure illustrated in FIG. 5A. It is assumed that the product X has a structure illustrated in FIG. 5D as an example, and assemblies A and C have structures illustrated in FIG. 5B and FIG. 5C, respectively. As clear from FIG. 5A through FIG. 5D, the assembly A is formed by assembling parts a2 and a3 to a part a1. Additionally, the assembly C is formed by assembling parts b and c to the assembly A, and the product X is formed by assembling assemblies D and E to the assembly C.

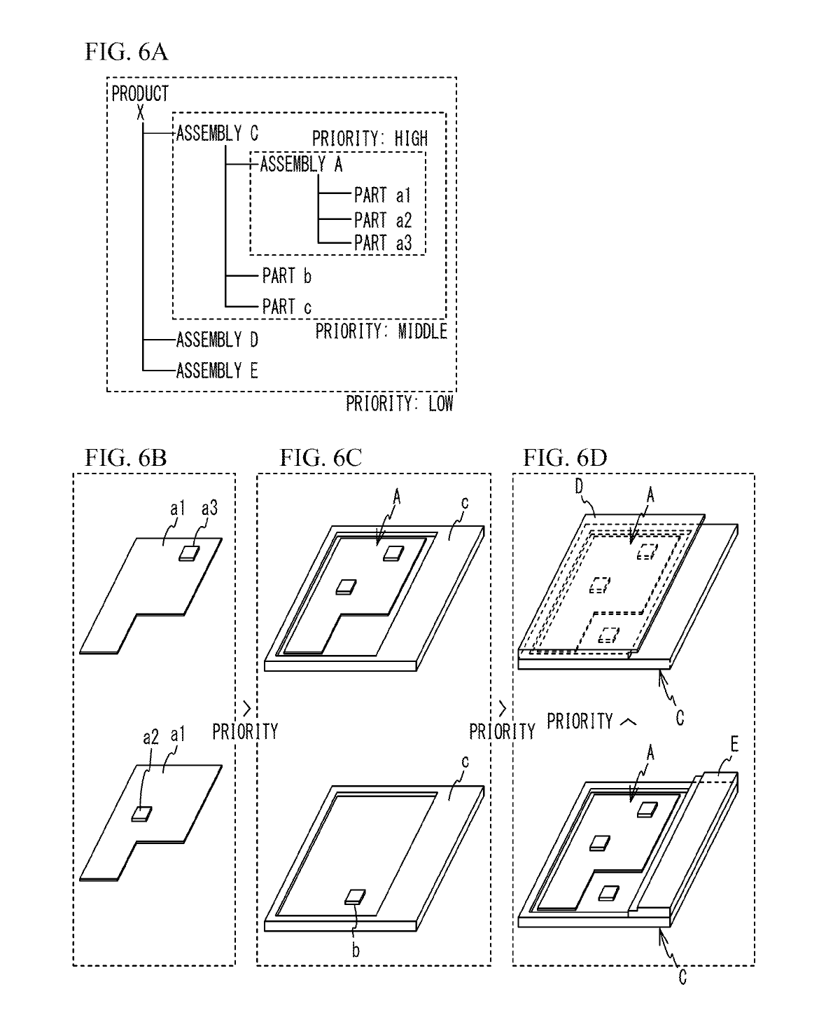

Thus, the priority derived from the constraint on assembly (the constraint that assemblies are assembled individually) becomes as presented in FIG. 6A. The priority of the task assembling the assembly A is “HIGH”, the priority of the task assembling the assembly C is “MIDDLE”, and the priority of the task assembling the assemblies D and E to the assembly C is “LOW”. The priority is the same between the task assembling the part a3 to the part a1 presented in the upper part of FIG. 6B and the task assembling the part a2 to the part a1 presented in the lower part of FIG. 6B because any one of the tasks can be executed first. In addition, the priority is the same between the task assembling the assembly A to the part c presented in the upper part of FIG. 6C and the task assembling the part b to the part c presented in the lower part of FIG. 6C. On the other hand, for the task assembling the assembly D to the assembly C presented in the upper part of FIG. 6D and the task assembling the assembly E to the assembly C presented in the lower part of FIG. 6D, since the assembly E is preferably assembled first in terms of the structures of the assemblies D and E, the task presented in the lower part of FIG. 6D has higher priority based on the assembling order than the task presented in the upper part of FIG. 6D. In the present embodiment, the priority DB 52 in FIG. 2 stores the information on priority of each task, which is determined based on the information on priority based on the constraint on assembly illustrated in FIG. 6A and the information on priority based on the assembling order illustrated in FIG. 6D.

Referring back to FIG. 2, the robotization task extraction unit 22 extracts a task to be assigned to a robot system from tasks to be executed in the assembly line. More specifically, the robotization task extraction unit 22 extracts a task to be assigned to a robot system based on the positional relationship between the person and the robot system in the assembly line, the information in the task DB 50 (for example, the information indicating whether each task is able to be assigned to a robot system), and the like.

The process plan formulation unit 24 assigns tasks to the person and the robot system assigned to each station of the assembly line by using the extraction results by the robotization task extraction unit 22 to formulate a process plan. The process plan formulation unit 24 considers a plurality of parameters including parameters about workability of the person and the robot system when assigning tasks to the person and the robot system assigned to each station. The parameters include temporal variability among stations, a parameter indicating whether the same tool is integrated in a particular station, and a parameter indicating whether the priority defined in the priority DB 52 is followed.

The display control unit 26 generates a screen that displays the process plan formulated by the process plan formulation unit 24, and displays the generated display screen on the display unit 93.

### Regarding Process

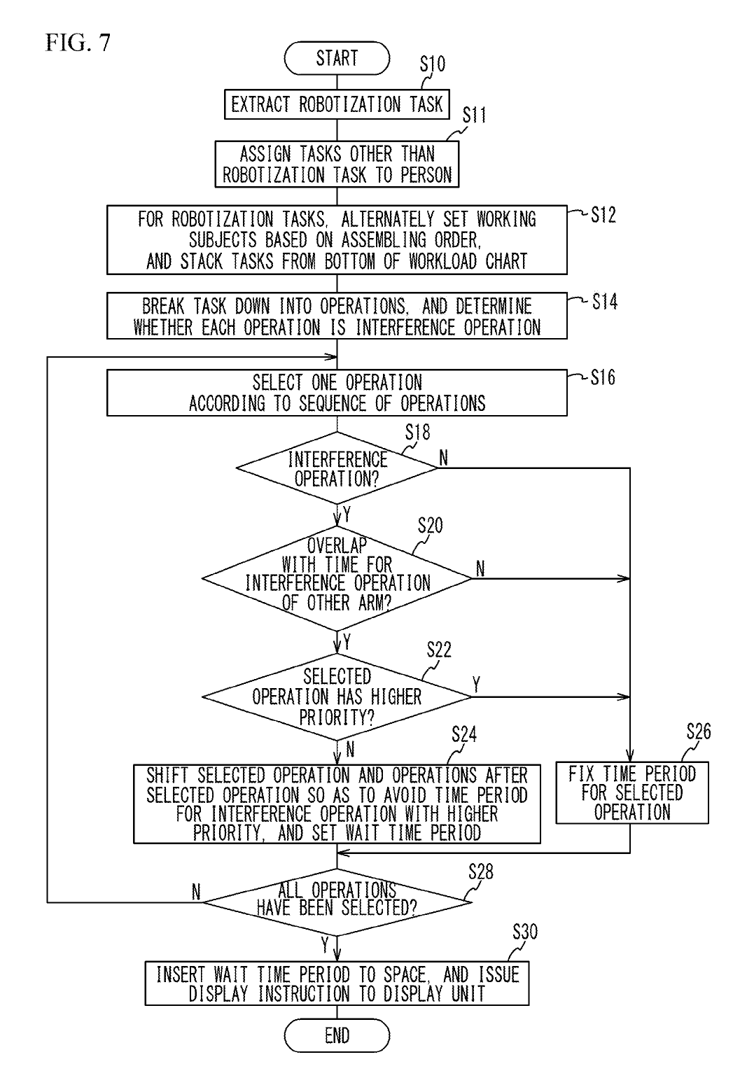

A detailed description will be next given of a process executed by the information processing device 10 along a flowchart of FIG. 7 with reference to other drawings as appropriately. The process of FIG. 7 is started when the input reception unit 20 receives information necessary to formulate a process plan input by the process designer.

In the process of FIG. 7, at step S10, the robotization task extraction unit 22 extracts a robotization task from tasks to be executed in the assembly line. In this case, as described previously, the robotization task extraction unit 22 extracts a task to be assigned to the robot system based on the positional relationship between the person and the robot system in the assembly line and information stored in the task DB 50.

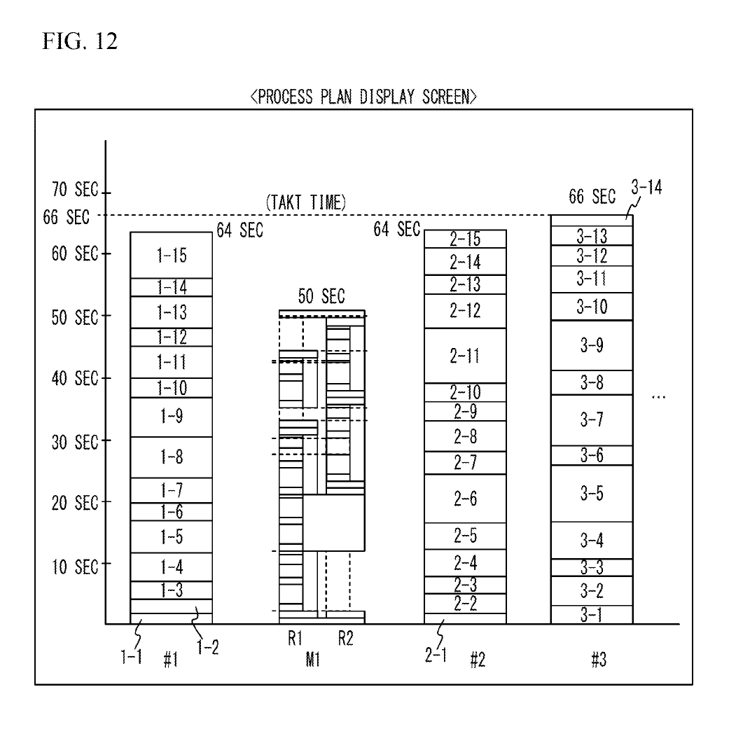

Then, at step S11, the process plan formulation unit 24 executes a process of assigning tasks other than robotization tasks to the person assigned to each station. In this case, as described previously, tasks are assigned to each person in consideration of the parameters such as temporal variability among stations, a parameter indicating whether the same tool is integrated in a particular station, and a parameter indicating whether the priority defined in the priority DB 52 is followed. The assignment result of tasks to each person can be presented by workload charts (piling charts) represented by #1, #2, #3, . . . in FIG. 12. In the case of FIG. 12, for example, a person #1 sequentially executes tasks from the bottom like 1-1, 1-2, 1-3 . . . . The width in the vertical direction of the frame of each task piled up in the workload chart represents a workload (the time required for the task)

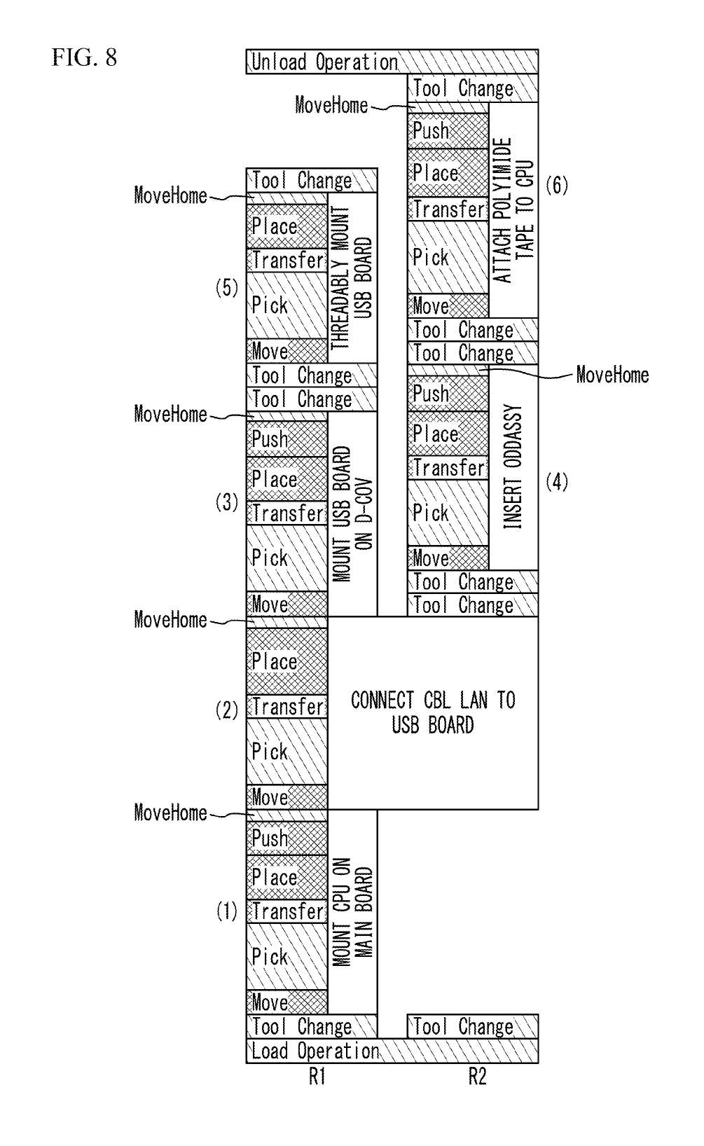

Then, at step S12, the process plan formulation unit 24 alternately sets the working subjects based on the assembling order for the robotization tasks, and stacks the tasks in order from the bottom of the workload chart with respect to each working subject. FIG. 8 illustrates the state where two arms of the robot system are set as the working subjects, and tasks are alternately assigned to the two arms according to the priority. In the example of FIG. 8, tasks indicated by (1) through (6) are assigned to two arms R1 and R2, and the priority is higher in the order of (1), (2), (3), (4), (5), and (6). Additionally, since the task (2) of the tasks (1) through (6) is a cooperative task to be executed by two arms, the task (2) is assigned to both the arms R1 and R2. Since there is a case where “Tool Change” needs to be executed at the timing between tasks, a frame “Tool Change” is inserted between tasks as appropriate.

Referring back to FIG. 7, at next step S14, the process plan formulation unit 24 breaks the task down into operations, and determines whether each operation is the interference operation. In FIG. 8, the task of each arm is indicated by a frame without hatching, and an operation included in each task is indicated by a hatched frame. In addition, among operations indicated by a hatched frame, the interference operation (the operation in the interference region) is indicated by a cross-hatched frame, and the non-interference operation (the operation in the non-interference region) is indicated by a single-hatched frame. The tool change is the operation in the non-interference region, and is thus, indicated by a single-hatched frame. The dimension in the vertical direction of each frame in FIG. 8 represents the time required for each task or operation.

In the example of the task (1) in FIG. 8, “MOUNT CPU ON MAIN BOARD” is a task, and operations broken down from the task are “Move”, “Pick”, “Transfer”, “Place”, “Push”, and “MoveHome”. In addition, the operations “Move”, “Transfer”, “Place”, and “Push” are the interference operations, and the operations “Pick” and “MoveHome” are the non-interference operations.

Then, at step S16, the process plan formulation unit 24 selects one operation according to the sequence of operations. The order of the operation is faster as the priority of the task in which the operation is included is higher, and when the operations are included in the same task, the order of the operation located lower in the workload chart is faster. In the example of FIG. 8, the operation “Move” of the task (1) is selected.

Then, at step S18, the process plan formulation unit 24 determines whether the selected operation is the interference operation. In the case of the operation “Move” of the task (1), since the operation “Move” is the interference operation, the determination at step S18 becomes Yes, and the process moves to step S20. At step S20, the process plan formulation unit 24 determines whether the selected operation overlaps with the time for the interference operation of the other arm. In the case of the operation “Move” of the task (1), since the operation “Move” does not overlap with the time for the interference operation of the other arm, the determination at step S20 becomes No, and the process moves to step S26.

At step S26, the process plan formulation unit 24 fixes the time period for the selected operation. That is, the time period for the operation “Move” of the task (1) is fixed.

Then, at step S28, the process plan formulation unit 24 determines whether all operations have been selected. When the determination at step S28 is No, the process returns to step S16.

At step S16, the process plan formulation unit 24 selects the operation “Pick” of the task (1) as the next operation (S16), and determines whether the selected operation is the interference operation (S18). In this case, since the operation “Pick” is not the interference operation (S18: No), the time period for the operation “Pick” of the task (1) is fixed (S26), and the process moves to step S28.

Thereafter, the same processes as those described above are repeated for the remaining operations of the task (1) and all operations of the task (2).

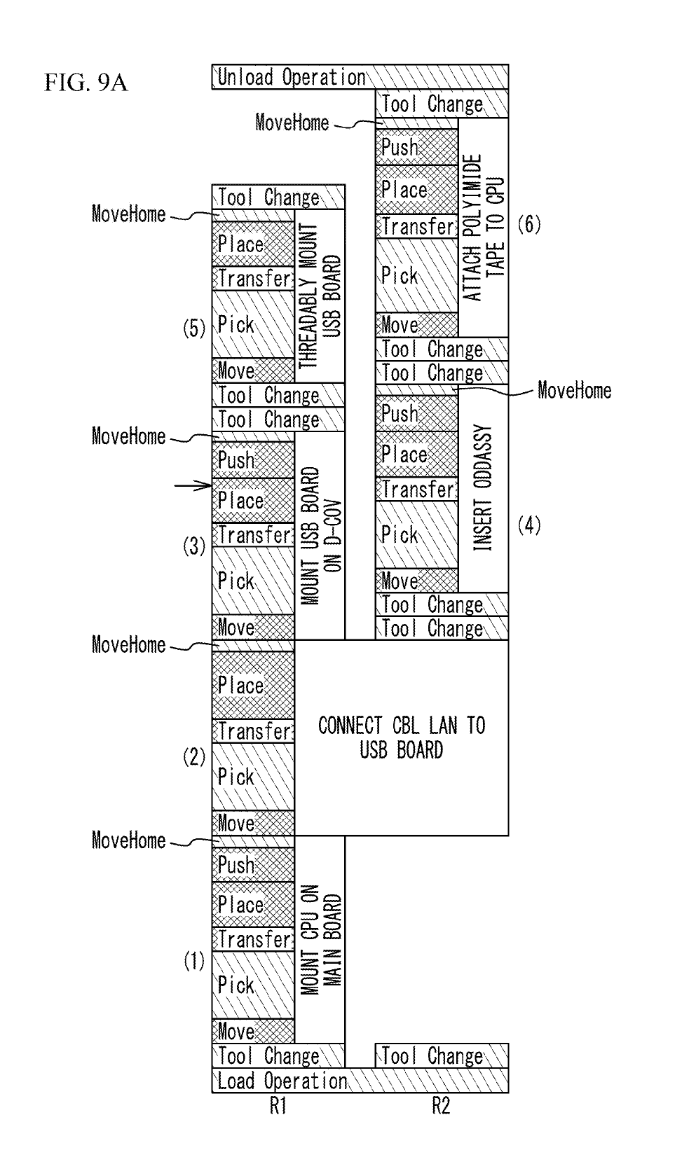

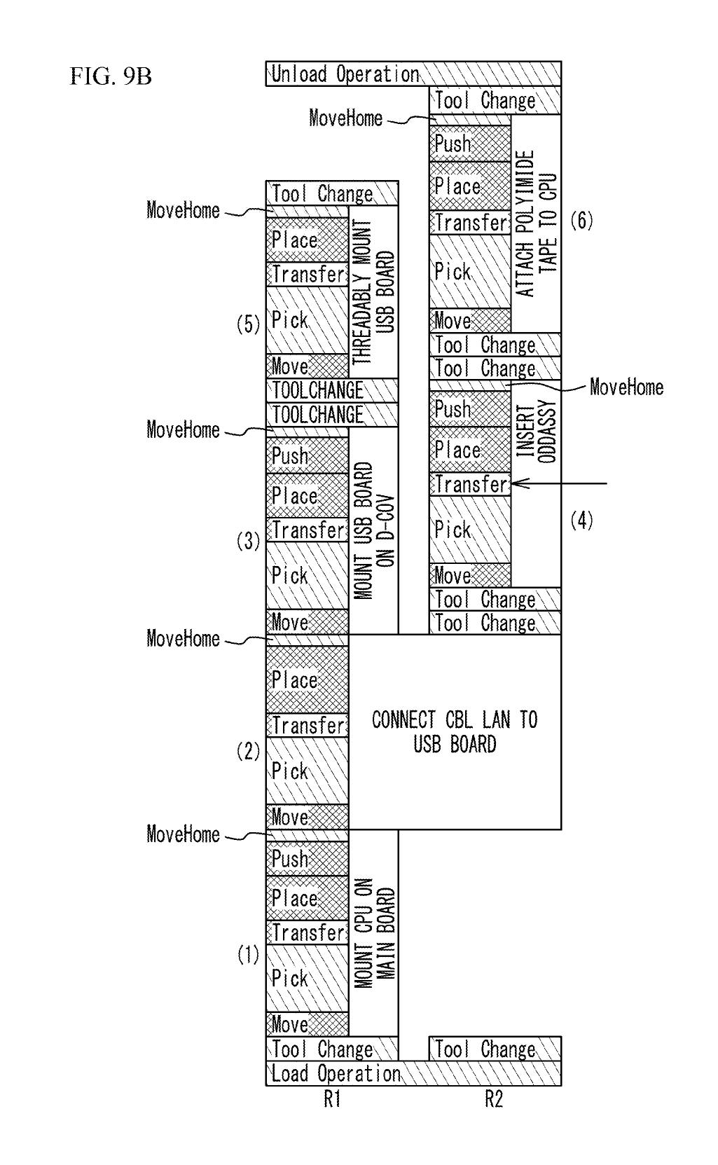

Then, the process plan formulation unit 24 repeats the above described processes to the operations of the task (3), and when selecting the operation “Place” of the task (3) indicated by a solid line arrow in FIG. 9A (S16), determines whether the selected operation is the interference operation (S18). In this case, it is determined that the selected operation is the interference operation (S18: Yes). Then, the process plan formulation unit 24 determines whether the selected operation overlaps with the time for the interference operation of the other arm (S20). Since the operation “Place” of the task (3) overlaps with the operation “Transfer” of the task (4) of the other arm R2 (S20: Yes), the process moves to step S22. At step S22, the process plan formulation unit 24 determines whether the selected operation has higher priority than the interference operation overlapping with the selected operation in time. Here, the interference operation of the other arm overlapping with the operation “Place” of the task (3) is the operation of the task (4). In this case, the task (3) has higher priority than the task (4). Thus, the process plan formulation unit 24 determines that the operation “Place” of the task (3) has higher priority (step S22: Yes). In this case, the process moves to step S26, and the process plan formulation unit 24 fixes the time period for the selected operation (“Place” of the task (3)), and moves to step S28.

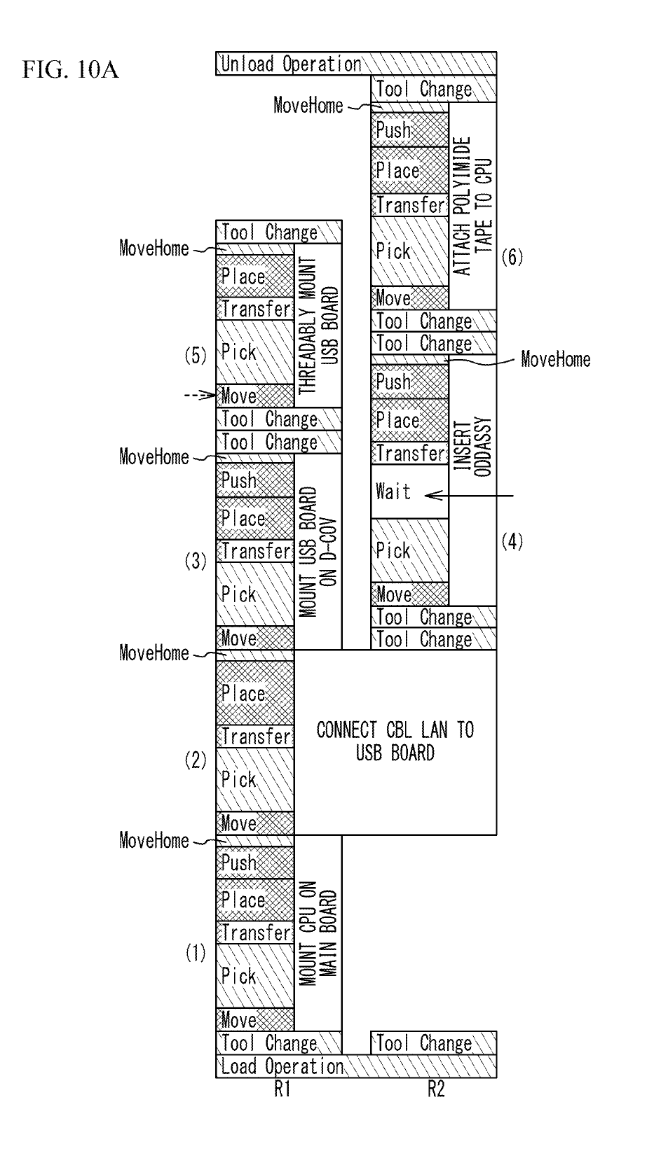

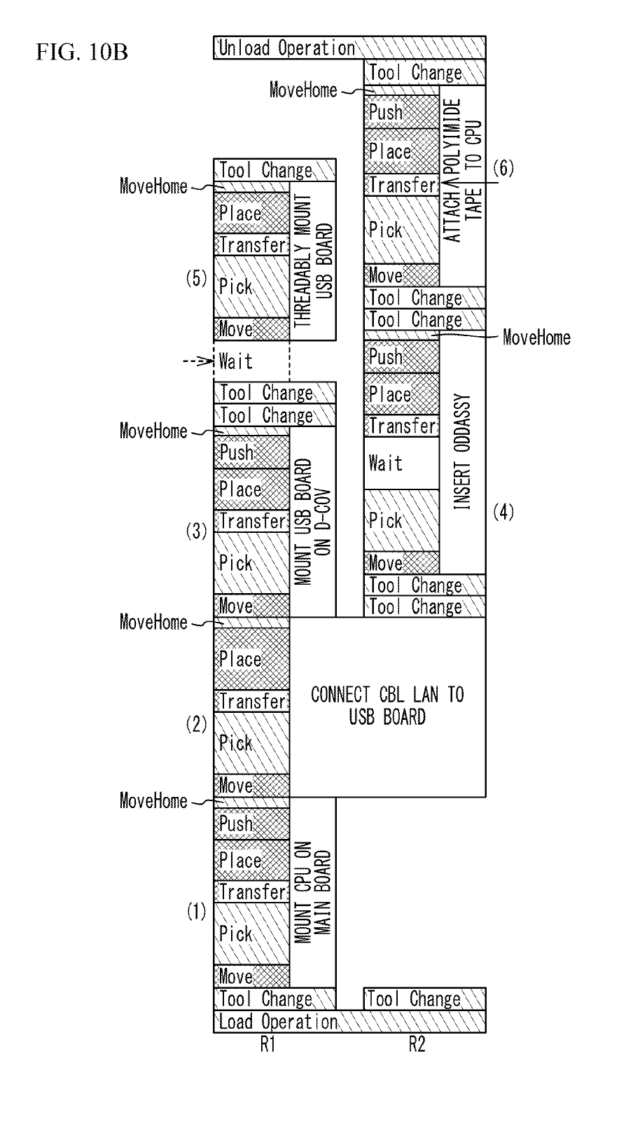

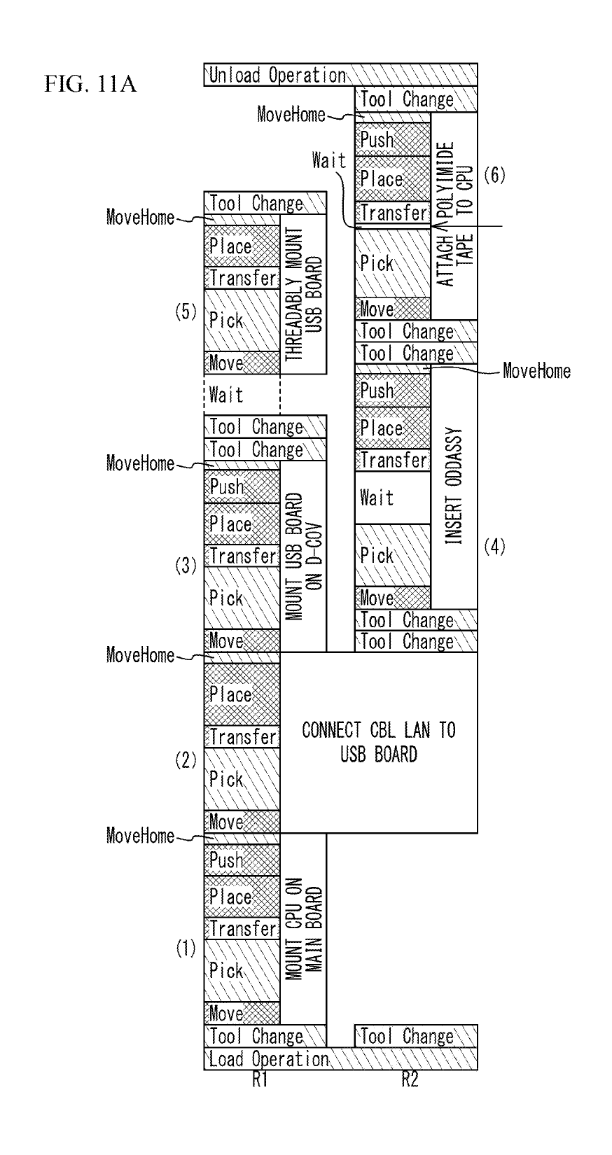

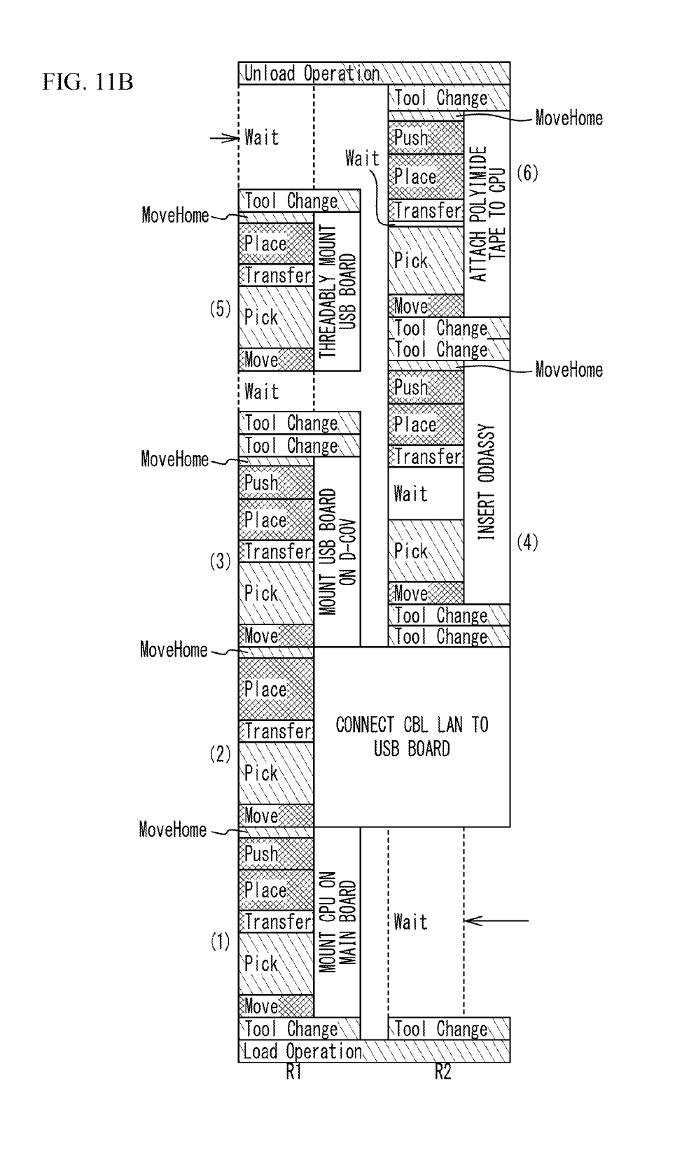

Thereafter, the process plan formulation unit 24 executes the above described processes to the remaining operations of the task (3) and the operations “Move” and “Pick” of the task (4). When the process plan formulation unit 24 selects the operation “Transfer” of the task (4) indicated by a solid line arrow in FIG. 9B (S16), since the selected operation is the interference operation (S18: Yes), the process moves to step S20. At step S20, the process plan formulation unit 24 determines whether the selected operation overlaps with the time for the interference operation of the other arm (S20). In this case, since the operation “Transfer” of the task (4) overlaps with the interference operation (the operation “Place” of the task (3)) of the other arm R1 (S20: Yes), the process moves to step S22, and the process plan formulation unit 24 determines whether the selected operation has higher priority than the interference operation overlapping with the selected operation in time. In this case, since the selected operation (the operation “Transfer” of the task (4)) has lower priority than the interference operation (the operation “Place” of the task (3)), the determination at step S22 becomes No, and the process moves to step S24. At step S24, the process plan formulation unit 24 shifts the selected operation and the operations after the selected operation so as to avoid the time period for the interference operation with a higher priority, and sets a wait time period. That is, in the state of FIG. 9B, the process plan formulation unit 24 shifts the operation “Transfer” of the task (4) of the arm R2 and the operations after the operation “Transfer” of the task (4) of the arm R2 to the upper side as illustrated in FIG. 10A to avoid the overlap with other interference operations. The process plan formulation unit 24 then inserts “Wait” to the time period from which the operations have been shifted (see a solid line arrow in FIG. 10A). As described above, on completion of the process at step S24, the process moves to step S28.

Thereafter, the process plan formulation unit 24 selects the operations “Place”, “Push”, and “MoveHome” of the task (4). In the case of the operations “Place” and “Push”, after the determination at step S22 becomes Yes, the process moves to step S28 through step S26. In addition, in the case of the operation “MoveHome”, after the determination at step S18 becomes No, the process moves to step S28 through step S26.

Then, when the process plan formulation unit 24 selects the operation “Move” of the task (5) indicated by a dashed line arrow in FIG. 10A, after the determinations at steps S18 and S20 become Yes, the determination at step S22 becomes No. Thus, the process moves to step S24. In this case, the process plan formulation unit 24 shifts the operation “Move” of the task (5) of the arm R1 and the operations after the operation “Move” of the task (5) of the arm R1 to the upper side at step S24 as indicated by a dashed line arrow in FIG. 10B to avoid the overlap with the interference operation of the other arm, and inserts “Wait” to the time period from which the operations have been shifted.

Thereafter, the process plan formulation unit 24 selects the remaining operations “Pick”, “Transfer”, “Place” and “MoveHome” of the task (5) and the operations “Move” and “Pick” of the task (6) sequentially. In any cases, the process moves to step S28 after step S26. Then, the process plan formulation unit 24 selects the operation “Transfer” of the task (6) indicated by a solid line arrow in FIG. 10B. In this case, the determinations at steps S18 and S20 become Yes, and the determination at step S22 becomes No. Thus, the process moves to step S24. At step S24, the process plan formulation unit 24 shifts the operation “Transfer” of the task (6) of the arm R2 and operations after the operation “Transfer” of the task (6) of the arm R2 to the upper side as indicated by a solid line arrow in FIG. 11A to avoid the overlap with the interference operation, and inserts “Wait” to the time period from which the operations have been shifted.

Thereafter, the process plan formulation unit 24 selects the operations “Place”, “Push”, and “MoveHome” of the task (6), and in any cases, the process moves to step S28 through step S26.

When all the operations have been selected in the above-described manner, the determination at step S28 becomes Yes, and the process moves to step S30.

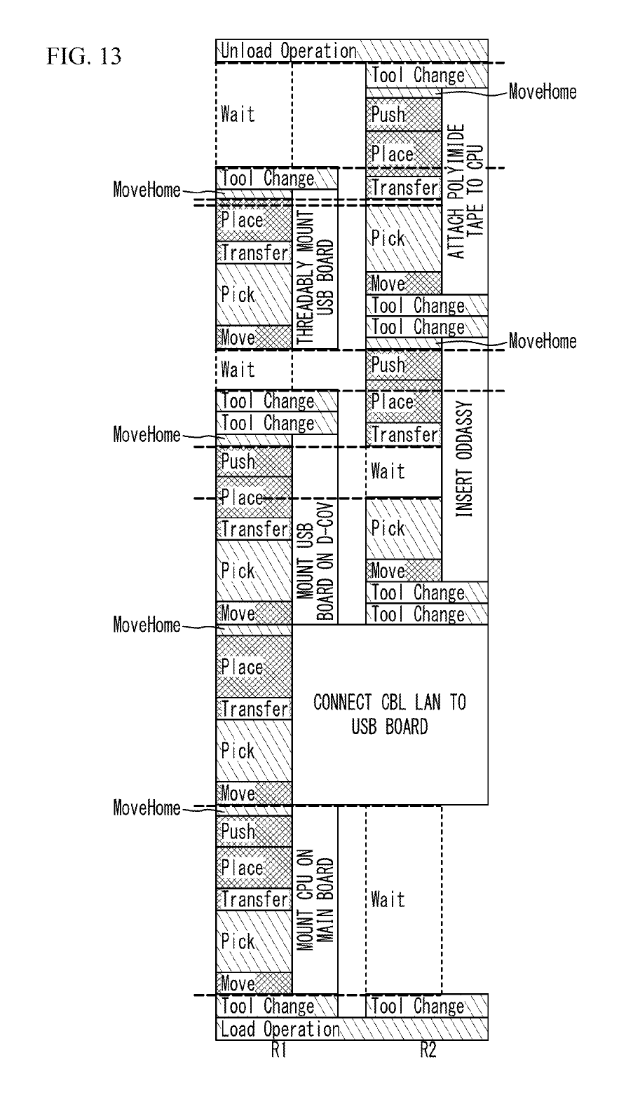

At step S30, the display control unit 26 inserts the wait time periods to the spaces in the workload chart as indicated by solid line arrows in FIG. 11B and adds necessary information as appropriate to generate the workload chart of the robot system (see FIG. 13). Then, the display control unit 26 generates a process plan display screen in which the generated workload chart of the robot system and the workload charts of the persons are arranged side by side (see FIG. 12), and instructs the display unit 93 to display the generated display screen.

Here, the process plan display screen in FIG. 12 displays the workload charts of the persons (#1, #2, #3, . . . ) and the workload chart of the robot system (M1) side by side, and also displays information such as time required for each process and takt time. As described above, displaying the workload chart of the person and the workload chart of the robot system side by side allows the process designer to check the load balance between the station to which a robot system is assigned and the station to which a person is assigned and to check absence and presence of the time for the person to wait the task of the robot system.

FIG. 13 is an enlarged view of the workload chart of the robot system (M1). In FIG. 13, the workload charts of the two arms R1 and R2, in each of which the execution time periods for respective operations and the wait time periods are arranged along the time axis, are displayed side by side. More specifically, in the workload chart presented in FIG. 13, tasks assigned to the robot system and operations included in the tasks are displayed, and interference operations and non-interference operations are displayed in a distinguishable manner by using different types of hatching. In FIG. 13, the wait time period (“Wait”) of each arm is displayed so as to be distinguishable from other operations. This allows the process designer to easily check details (workload, the start time and the end time of the task) of the tasks of each of two arms, and easily check whether two arms do not simultaneously execute the interference operations and whether the wait time period is appropriate (is not too long).

Additionally, in the workload chart presented in FIG. 13, bold dashed lines are displayed so that it can be seen which wait time period (“Wait”) of one arm corresponds to which time period for the operation of the other arm. This allows the process designer to easily check whether there is an unnecessary wait time (stop time) in each arm. When there is an unnecessary wait time, the process designer can issue a modification instruction to the information processing device 10 so that the process plan is reviewed. In this case, the information processing device 10 reviews the process plan taking into account the contents of the modification instruction from the process designer.

Furthermore, in FIG. 13, since the task cooperatively executed by two arms is displayed so as to spread over the workload charts of two arms, it can be easily checked whether the task cooperatively executed by two arms does not overlap with a single-arm task.

As described above in detail, in the present embodiment, the process plan formulation unit 24 assigns tasks to be executed to each arm of the robot system M1 having two arms R1 and R2 (S11), and determines the execution time period for each operation based on whether each operation of each task assigned to each arm is the interference operation or the non-interference operation (S12 through S28). Then, the display control unit 26 generates the process plan display screen that displays workload charts of the arms, in each of which the execution time periods for the operations and the wait time periods during which no operation is executed are arranged along a time axis, side by side, and displays the generated process plan display screen on the display unit 93 (S30). As described above, by displaying the respective workload charts of the arms, in each of which the time periods during which an operation is executed and wait time periods are arranged along a time axis, side by side, compared to the case where the workload of the robot system is displayed by simply stacking tasks, the process designer can easily check whether the execution time period for each operation of each arm and the wait time period are appropriate. Here, when each of two arms of the robot system executes a single-arm task, to avoid interference (collision), it is common to stop the arm that is not executing a task. However, as the number of tasks assigned to a robot increases, the stop time (wait time) of the arm increases, and thus the efficiency decreases. However, by generating the display screen illustrated in FIG. 12 and FIG. 13 and presenting the display screen to the process designer, the process designer can appropriately determine the appropriateness of the operation time and the wait time of the arm.

Additionally, in the present embodiment, the display control unit 26 displays the time period during which the interference operation is executed, the time period during which the non-interference operation is executed, and the wait time period in a distinguishable manner by using different types of hatching or the like. Thus, the process designer can easily check the overlap of the time periods and the appropriateness of the length of each time period.

Additionally, in the present embodiment, the display control unit 26 displays the start timing and the end timing of the wait time period of one of two arms also in the workload chart of the other arm (see a bold dashed line in FIG. 13). This allows the process designer to easily check whether there is an unnecessary wait time in each arm.

In the present embodiment, the display control unit 26 displays the time period during which two arms cooperatively work so that the time period spreads over the workload charts of the two arms. This allows the process designer to easily check whether there is a collaborative task.

In addition, in the present embodiment, since the display control unit 26 displays the workload chart of the station to which a person is assigned next to the workload chart of the robot system, the process designer can easily check the load balance between the station to which the robot system is assigned and the station to which the person is assigned, and check whether there is a time for the person to need to wait for the task of the robot system.

In the above embodiment, to distinguish the interference operation from the non-interference operation (and the wait time period), different types of hatching are used, but this does not intend to suggest any limitation. That is, the interference operation and the non-interference operation (and the standby time) can be distinguished by other methods (character size, font, or color) other than types of hatching.

In the above embodiment, the start timing and the end timing of the wait time period of one of the arms is displayed in the workload chart of the other arm by using a bold dashed line illustrated in FIG. 13, but this does not intend to suggest any limitation. For example, a predetermined indication (a double-headed arrow indicating the wait time period) may be displayed in the workload chart of the other arm so that the wait time period of one arm can be recognized.

The above embodiment has described a case where the robot system has two arms, but this does not intend to suggest any limitation, and the robot system may have three or more arms. Even in this case, it is sufficient if the workload charts of individual arms are displayed side by side on the process plan display screen in the same manner as the above embodiment.

The above-described processing functions are implemented by a computer. In this case, a program in which processing details of the functions that a processing device (CPU) is to have are written are provided. The execution of the program by the computer allows the computer to implement the above described processing functions. The program in which the processing details are written can be stored in a storage medium (however, excluding carrier waves) capable of being read by a computer.

When the program is distributed, it may be sold in the form of a portable storage medium such as a DVD (Digital Versatile Disc) or a CD-ROM (Compact Disc Read Only Memory) storing the program. The program may be stored in a storage device of a server computer, and the program may be transferred from the server computer to another computer over a network.

A computer executing the program stores the program stored in a portable storage medium or transferred from a server computer in its own storage device. The computer then reads the program from its own storage device, and executes a process according to the program. The computer may directly read the program from a portable storage medium, and execute a process according to the program. Alternatively, the computer may successively execute a process, every time the program is transferred from a server computer, according to the received program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An information processing device comprising:
a memory; and
a processor coupled to the memory and configured to:
assign a task to be executed to each arm of a robot system having arms;
determine an execution time period for each operation included in each task assigned to the each arm based on whether the each operation is an operation in an interference region, in which the arms interfere with each other, or an operation in a non-interference region, in which the arms do not interfere with each other; and
display workload charts of the arms side by side, an execution time period for each operation and a time period during which no operation is executed being arranged along a time axis in the workload chart of the each arm.

2. The information processing device according to claim 1, wherein
the processor is configured to display a time period during which an operation is executed in the interference region, a time period during which an operation is executed in the non-interference region, and a time period during which no operation is executed and wait is executed in a distinguishable manner.

3. The information processing device according to claim 1, wherein
the processor is configured to display a start timing and an end timing of a time period during which one of the arms executes no operation and waits in both of the workload charts of the arms.

4. The information processing device according to claim 1, wherein
the processor is configured to display a time period during which at least two arms of the arms cooperatively operate across the workload charts of the at least two arms.

5. The information processing device according to claim 1, wherein
the processor is configured to display a workload chart indicating an execution sequence of tasks assigned to a person and a time required for each task of the tasks next to the workload chart of the robot system.

6. A non-transitory computer readable storage medium storing a process plan display program causing a computer to execute a process, the process comprising:
assigning a task to be executed to each arm of a robot system having arms;
determining an execution time period for each operation included in each task assigned to the each arm based on whether the each operation is an operation in an interference region, in which the arms interfere with each other, or an operation in a non-interference region, in which the arms do not interfere with each other; and
displaying workload charts of the arms side by side, an execution time period for each operation and a time period during which no operation is executed being arranged along a time axis in the workload chart of the each arm.

7. The non-transitory computer readable storage medium to claim 6, wherein
the displaying includes displaying a time period during which an operation is executed in the interference region, a time period during which an operation is executed in the non-interference region, and a time period during which no operation is executed and wait is executed in a distinguishable manner.

8. The non-transitory computer readable storage medium according to claim 6, wherein
the displaying includes displaying a start timing and an end timing of a time period during which one of the arms executes no operation and waits in both of the workload charts of the arms.

9. The non-transitory computer readable storage medium according to claim 6, wherein
the displaying includes displaying a time period during which at least two arms of the arms cooperatively operate across the workload charts of the at least two arms.

10. The non-transitory computer readable storage medium according to claim 6, wherein
the displaying includes displaying a workload chart indicating an execution sequence of tasks assigned to a person and a time required for each task of the tasks next to the workload chart of the robot system.

11. A method of displaying a process plan implemented by a computer, the method comprising:
assigning a task to be executed to each arm of a robot system having arms;
determining an execution time period for each operation included in each task assigned to the each arm based on whether the each operation is an operation in an interference region, in which the arms interfere with each other, or an operation in a non-interference region, in which the arms do not interfere with each other; and
displaying workload charts of the arms side by side, an execution time period for each operation and a time period during which no operation is executed being arranged along a time axis in the workload chart of the each arm.
